(19) United States
(12) Patent Application Publication
(10) Pub. No.: US 2014/0204102 A1
(43) Pub. Date: Jul. 24, 2014

(54) USING GRAPHICS PROCESSING UNITS IN CONTROL AND/OR DATA PROCESSING SYSTEMS

(71) Applicant: THE TRUSTEES OF COLUMBIA UNIVERSITY IN THE CITY OF NEW YORK, New York, NY (US)

(72) Inventors: Nikolaus Rath, New York, NY (US); Gerald A. Navratil, Nyack, NY (US)

(21) Appl. No.: 14/118,517

(22) PCT Filed: May 18, 2012
(86) PCT No.: PCT/US2012/038697

§ 371 Date: Apr. 1, 2014

Related U.S. Application Data
(60) Provisional application No. 61/488,022, filed on May 19, 2011.

(51) Int. Cl. G06T 1/20

(52) U.S. Cl. CPC G06T 1/20
USPC 345/522

(57) ABSTRACT

A graphics processing unit (GPU) can be used in control and/or data processing systems that require high speed data processing with low input/output latency (i.e., fast transfers into and out of the GPU). Data and/or control information can be transferred directly to and/or from the GPU without involvement of a central processing unit (CPU) or a host memory. That is, in some embodiments, data to be processed by the GPU can be received by the GPU directly from a data source device, bypassing the CPU and host memory of the system. Additionally or alternatively, data processed by the GPU can be sent directly to a data destination device from the GPU, bypassing the CPU and host memory. In some embodiments, the GPU can be the main processing unit of the system, running independently and concurrently with the CPU.

### CROSS REFERENCE TO RELATED APPLICATION

This claims the benefit of U.S. Provisional Patent Application No. 61/488,022, filed May 19, 2011, which is hereby incorporated by reference herein in its entirety.

### STATEMENT REGARDING FEDERALLY SPONSORED RESEARCH OR DEVELOPMENT

The invention was made with government support under Grant No. DE-FG02-86ER53222 awarded by the U.S. Department of Energy. The U.S. government has certain rights in the invention.

### TECHNICAL FIELD

The disclosed subject matter relates to systems, methods, and media for using graphics processing units in control and/or data processing systems.

### BACKGROUND

Current mid-end real-time control and/or data processing systems typically use either field programmable gate arrays (FPGAs) or multiprocessor personal computer (PC) based systems to carry out computations. FPGAs provide a high level of parallelism in computations, but can be difficult to program. PC-based systems can be easy to program in standard programming languages such as C, but have a limited number of cores that can significantly limit the amount of parallelism that can be achieved. A “core” can be defined as an independent processing unit, and some known PC-based systems can have at most, for example, 16 cores.

Graphics processing units (GPUs) were originally designed to assist a central processing unit (CPU) with the rendering of complex graphics. Because most operations involved in graphics rendering are intrinsically parallel, GPUs have a very high number of cores (e.g., 100 or more). Recently, the computing power of GPUs has been used for general-purpose, high performance computing where the time required for transferring data to and from the GPU (which can be referred to as input/output (I/O) latency) is negligible compared to the time required for computations. GPU computing combines the high parallelism of FPGAs with the ease of use of multiprocessor PCs, and can have a significant cost advantage over multiprocessor computing in cases where the algorithms themselves are parallel enough to take full advantage of the high number of GPU cores.

However, GPUs are not known to be used in applications where the I/O latency is not negligible in view of the time required for computations.

### SUMMARY

Systems, methods, and media for using graphics processing units (GPUs) in control and/or data processing systems are provided.

In accordance with some embodiments, methods of using a GPU in a control and/or data processing system are provided, the methods comprising: (1) allocating a region in a memory of a GPU as a data store; (2) communicating address information regarding the allocated region to a data source device and/or a data destination device; and (3) bypassing a central processing unit and a host memory coupled to the GPU to communicate data and/or control information between the GPU and the data source device and/or the data destination device.

In accordance with some embodiments, systems for using a GPU for process control and/or data processing applications are provided, the systems comprising a central processing unit (CPU), a host memory, a GPU, a data source device and/or a data destination device, and a computer bus coupled to the CPU, the host memory, the GPU, and the data source device and/or the data destination device. The data source device can be operative to bypass the CPU and the host memory to write data and/or control information directly to the GPU via the computer bus. The data destination device can be operative to bypass the CPU and the host memory to read data directly from the GPU via the computer bus.

In accordance with some embodiments, non-transitory computer readable media containing computer-executable instructions that, when executed by a processor, cause the processor to perform a method of using a GPU in a control and/or data processing system are provided, the method comprising: (1) requesting a device driver of a GPU to cause a region in a memory of a GPU to be allocated as a data store; (2) requesting the device driver of the GPU to cause a computer bus address range assigned to the GPU to be mapped to the allocated region; and (3) transmitting to a data source device and/or a data destination device (a) the computer bus address range assigned to the GPU and (b) instructions to use that computer bus address range to write to or read from the GPU.

### BRIEF DESCRIPTION OF THE DRAWINGS

FIG. 1 is a diagram illustrating a system using a graphical processing unit (GPU) in a known manner;

FIG. 2 is a diagram illustrating a system for using a GPU for control and/or data processing applications in accordance with some embodiments;

FIG. 3 is a diagram illustrating another system for using a GPU for control and/or data processing applications in accordance with some embodiments;

FIG. 4 is a diagram illustrating a data flow through a GPU used in a control and/or data processing system in accordance with some embodiments;

FIG. 5 is a flow diagram illustrating a process for using a GPU in a control and/or data processing system in accordance with some embodiments; and

FIGS. 6-9 show illustrative programming instructions for using a GPU in a control and/or data processing system in accordance with some embodiments.

### DETAILED DESCRIPTION

Systems, methods, and media for using graphics processing units (GPUs) in control and/or data processing systems are provided.

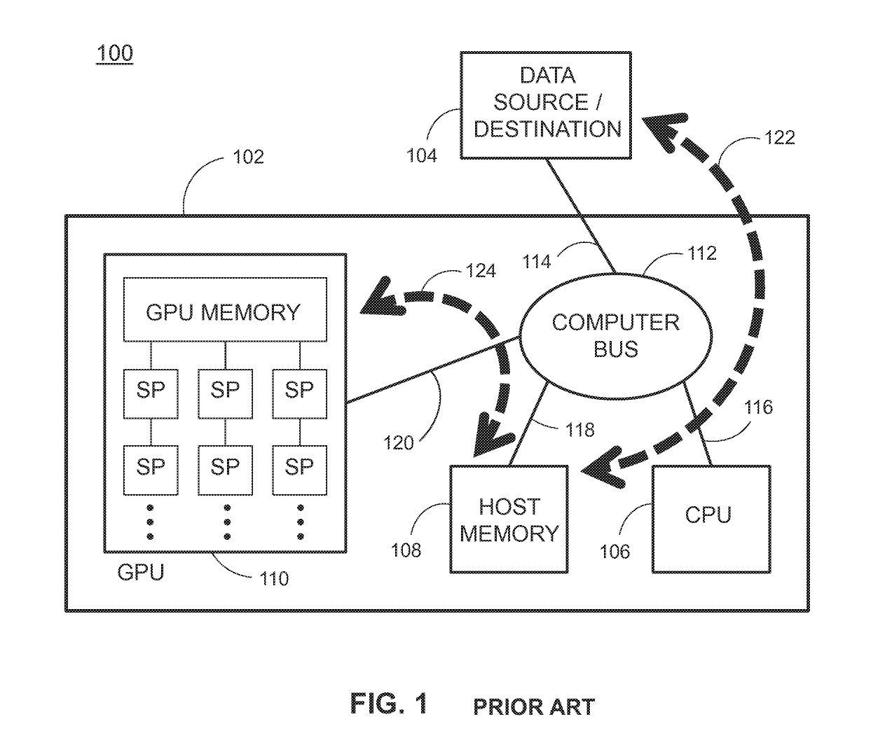

FIG. 1 shows an example of a generalized system 100 that can operate in a known manner. System 100 can include a computer 102 and a data source/destination device 104 coupled to computer 102. Data source/destination device 104 can be any suitable device for providing data and/or control information to computer 102 and/or for receiving data and/or control information from computer 102. Data source/destination device 104 can have analog-to-digital converter (ADC) capability and/or digital-to-analog converter (DAC) capability. Data source/destination device 104 can be two or more devices, such as, for example, a first device for providing data to computer 102, such as an ADC, and a second device for receiving data from computer 102, such as a DAC. Although shown as a separate device coupled to computer 102, data source/destination device 104 can be one or more integrated parts of computer 102 having appropriate input/output capability for receiving and sending analog inputs and outputs to various other devices coupled to computer 102. Alternatively, one of a data source function or a data destination function of data source/destination device 104 can be implemented as one or more integrated parts of computer 102.

Computer 102 can include a central processing unit (CPU) 106, a host memory 108, and a GPU 110 coupled to each other via a computer bus 112. CPU 106 can be, for example, a PC-based processor with a single or small number of cores (e.g., 16). Host memory 108 can be, for example, a random access memory (RAM). GPU 110 can include a GPU memory, which can be RAM, and a large number of stream processors (SPs) or cores (e.g., 100 or more). Computer bus 112 can have any suitable logic, switching components, and combinations of main, secondary, and/or local buses 114, 116, 118, and 120 operative to route “traffic” (i.e., data and/or control information) between (i.e., to and/or from) coupled components and/or devices (such as, e.g., data source/destination device 104, CPU 106, host memory 108, and GPU 110). Computer 102 can be, for example, any suitable general purpose device or special purpose device, such as a client or server.

System 100 can operate in a known manner by having a main application run on CPU 106 while specific computations can be offloaded to GPU 110. In this known architecture, the GPU can be subordinate to the CPU, which can function as the overall supervisor of any computation. That is, every action can be initiated by CPU 106, and all data may pass through host memory 108 before reaching its final destination. In particular, CPU 106 can mediate all communication between components and/or devices. To transfer data from data source/destination device 104 to GPU 110 (i.e., to perform a write operation to GPU 110's memory), the CPU can setup and schedule at least two memory access transactions, one from data source/destination device 104 to host memory 108 via computer bus 112, as illustrated by double-headed arrow 122 in FIG. 1, and a second transaction from host memory 108 to GPU 110's memory via computer bus 112, as illustrated by double-headed arrow 124. Similarly, to transfer data from GPU 110's memory to data source/destination device 104 (i.e., to perform a read operation from GPU 110's memory), the CPU can again setup and schedule at least two memory access transactions, but in the reverse order as described for the write operation. This arrangement can work well for applications in which the time required for computation is significantly longer than the time required for transferring data into and out of the GPU. The time to transfer data into and out of the GPU can be referred to herein as I/O latency.

However, in some applications, such as, for example, certain real-time feedback control applications, extremely fast parallel processing of small amounts of data can be required. This can result in very short computation times. In system 100, however, a significant percentage of the total runtime of such applications can be dominated by the GPU's I/O latency. That is, because the CPU can be directing the read and write activities of the GPU (i.e., setting up and scheduling multiple data transfers through the host memory), the I/O latency can be unacceptably high, and system 100 may therefore not be suitable for running such applications.

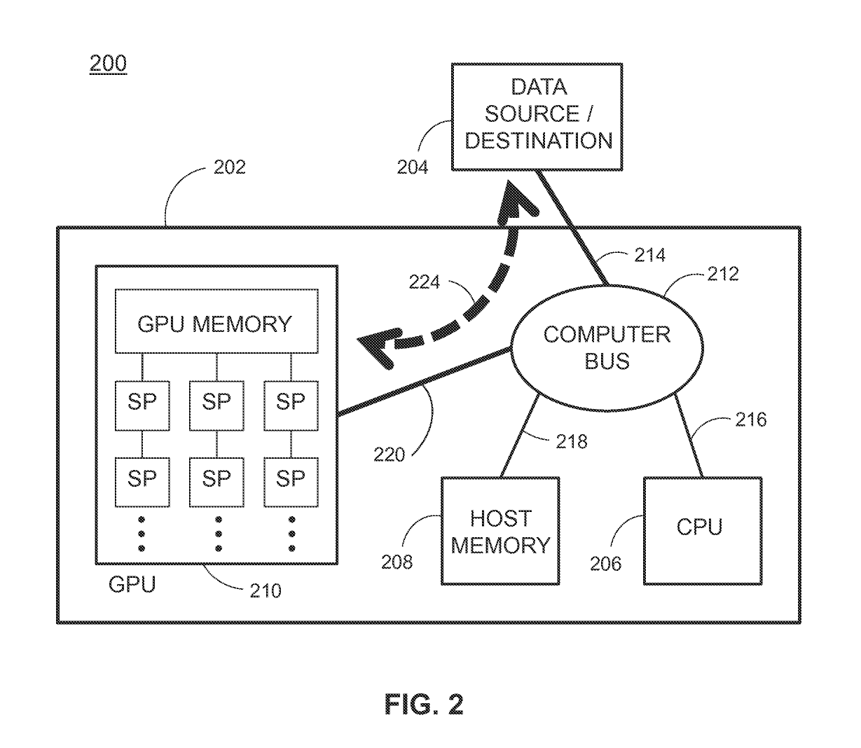

FIG. 2 shows an example of a generalized system 200 that can use a GPU in a process control and/or data processing application in accordance with some embodiments. The process control and/or data processing application may require low I/O latency in some embodiments. System 200 can include computer 202 and a data source/destination device 204 coupled to computer 202. Data source/destination device 204 can be any suitable device for providing data and/or control information to computer 202 and/or for receiving data and/or control information from computer 202. For example, in some embodiments, data source/destination device 204 can have analog-to-digital converter (ADC) capability and/or digital-to-analog converter (DAC) capability. In some embodiments, data source/destination device 204 can be two or more devices, such as, for example, a first device for providing data to computer 202, such as an ADC, and a second device for receiving data from computer 202, such as a DAC. Although shown as a separate device coupled to computer 202, data source/destination device 204 can be, in some embodiments, one or more integrated parts of computer 202 having appropriate input/output capability for receiving and sending analog inputs and outputs to various other devices coupled to computer 202. Alternatively, in some embodiments, one or more of a data source function or a data destination function of data source/destination device 204 can be implemented as one or more integrated parts of computer 202.

Computer 202 can include a central processing unit (CPU) 206, a host memory 208, and a graphics processing unit (GPU) 210 coupled to each other via a computer bus 212. CPU 206 can be, for example, a PC-based processor with a single or small number of cores. Host memory 208 can be any suitable memory, such as, for example, a random access memory (RAM). GPU 210 can include a GPU memory, which can be any suitable memory, such as, for example, RAM, and a large number of stream processors (SPs) or cores (e.g., 100 or more). Note that in some embodiments a large number of SPs may not be required. GPU 210 can be any suitable computing device in some embodiments. Computer bus 212 can have any suitable logic, switching components, and combinations of main, secondary, and/or local buses 214, 216, 218, and 220 capable of providing peer-to-peer transfers between coupled components and/or devices (such as, e.g., data source/destination device 204, CPU 206, host memory 208, and GPU 210). In some embodiments, data source/destination device 204 can be coupled to computer bus 212 via main bus 214, and GPU 210 can be coupled to computer bus 212 via main bus 220. CPU 206 can be coupled to computer bus 212 via local bus 216, and host memory 208 can be coupled to computer bus 212 via local bus 218. In some embodiments, computer bus 212 can conform to any suitable Peripheral Component Interconnect (PCI) bus standard, such as, for example, a PCI Express (PCIe) standard. In some embodiments, transfers between coupled components and/or devices can be direct memory access (DMA) transfers. In some embodiments, computer 202 can be, for example, any suitable general purpose device or special purpose device, such as a client or server.

System 200 can operate with low I/O latency in accordance with some embodiments as follows: CPU 206 can initialize system 200 upon power-up (described in more detail below) such that data source/destination device 204 and GPU 210 can operate concurrently with and independently of CPU 206. A write operation to GPU 210's memory from data source/destination device 204 can be performed by bypassing CPU 206 and host memory 208. That is, instead of having CPU 206 initiate a transfer of data and/or control information from data source/destination device 204 to host memory 208, and then have CPU 206 initiate another transfer from host memory 208 to GPU 210's memory, data source/destination device 204 can instead initiate a transfer of data and/or control information directly to GPU 210's memory via computer bus 212, as illustrated by double-headed arrow 224. Similarly, a read operation from GPU 210's memory to data source/destination device 204 can be performed by again bypassing CPU 206 and host memory 208. That is, instead of having CPU 206 initiate a transfer of data from GPU 210's memory to host memory 208, and then have CPU 206 initiate another transfer from host memory 208 to data source/destination device 204, data source/destination device 204 can instead initiate a transfer of data directly from GPU 210's memory to data source/destination device 204 via computer bus 212, as again illustrated by double-headed arrow 224.

GPU 210 can, in some embodiments, function as the main processing unit in system 200. Moreover, in some embodiments, no real-time operating system is required by GPU 210, because CPU 206 does not need to have guaranteed availability in view of the GPU processing the data. In some embodiments, CPU 206 can perform other tasks during GPU read and write operations, provided that those tasks do not cause excessive traffic on computer bus 212, which could adversely affect the speed of GPU read and/or write operations.

In system 200, the total number of transfers per GPU computation and/or the time required for a single transfer to or from the GPU can be reduced in comparison to system 100, because CPU 206 and host memory 208 are not involved in GPU read and write operations and associated computations. I/O latency can accordingly be lowered to levels that, in some embodiments, can be suitable for real-time process control and/or data processing applications.

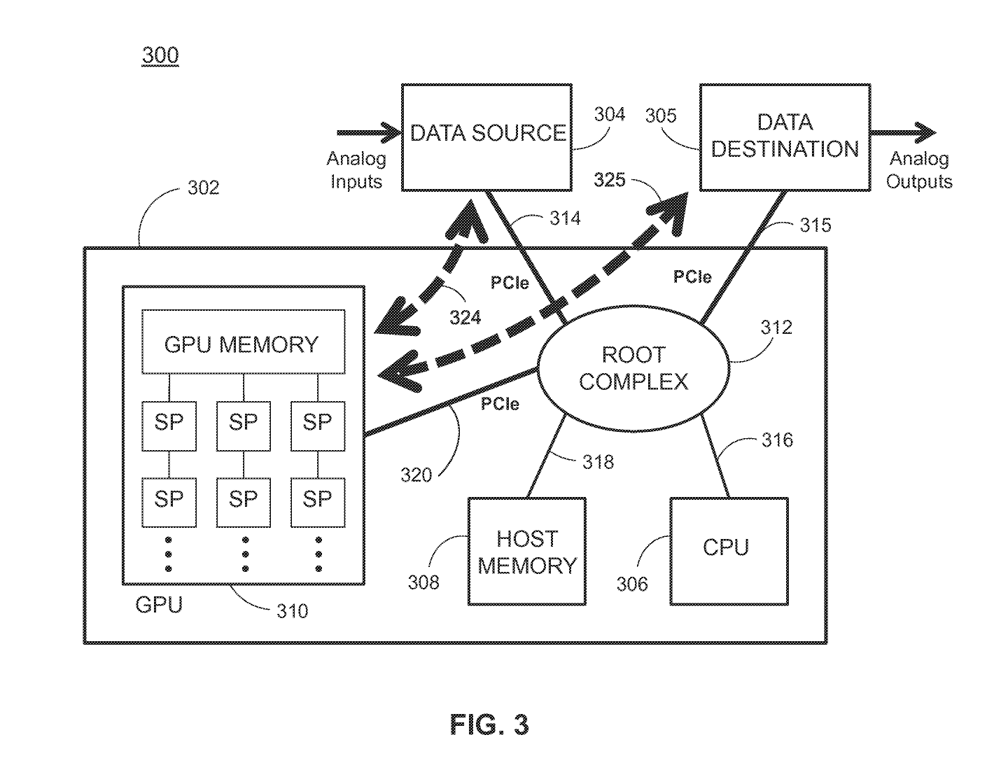

FIG. 3 shows another example of a system 300 that can use a GPU in a process control and/or data processing application in accordance with some embodiments. The process control and/or data processing application may require low I/O latency in some embodiments. System 300 can include a computer 302, a data source device 304, and a data destination device 305. Data source device 304 can include an ADC for converting analog inputs to digital data and can be, for example, a D-TACQ ACQ196, 96 channel, 16-bit digitizer with RTM-T (Rear Transition Module), available from D-TACQ Solutions Ltd., of Scotland, United Kingdom. Data destination device 305 can include a DAC for converting digital data received from computer 302 to analog outputs. Data destination device 305 can be, for example, two D-TACQ A032CPCI, 32 channel, 16-bit analog output modules each with RTM-T, also available from D-TACQ Solutions Ltd. Data source device 304 and/or data destination device 305 can be installed in, integrated with, and/or coupled to computer 302 in any suitable manner. Alternatively, other suitable data source devices and/or data destination devices, or combinations of data source/data destination devices, can be used in some embodiments.

Computer 302 can include a CPU 306 and a host memory 308 and can be, for example, a standard x86-based computer running a Linux operating system. In some embodiments, computer 302 can be a WhisperStation PC, available from Microway, Incorporated, of Plymouth, Mass. The WhisperStation PC can include a SuperMicro X8DAE mainboard, available from Super Micro Computer, Inc., of San Jose, Calif., running a 64-bit Linux operating system with kernel 3.0.0. Alternatively, any suitable computer and/or operating system can be used in some embodiments.

Computer 302 can include a GPU 310 which, in some embodiments, can be directly integrated into computer 302. GPU 310 can have a large number of stream processors (SPs) or cores and a GPU memory, which can be a random access memory (RAM). In some embodiments, GPU 310 can be a NVIDIA GeForce GTX 580 GPU, available from NVIDIA Corporation, of Santa Clara, Calif. This GPU can have 512 cores and 1.5 GB of GDDR5 (graphics double data rate, version 5) SDRAM (synchronous dynamic random access memory). In some embodiments, GPU 310 can alternatively be a NVIDIA C2050 GPU, having 448 cores and a 4 GB GDDR5 SDRAM. Alternatively, any other suitable GPU or comparable computing device can be used in computer 302 in some embodiments.

In some embodiments, GPU 310, data source device 304, and data destination device 305 can be coupled to a computer bus, which can be, for example, a Peripheral Component Interconnect Express (PCIe) bus system of computer 302. A PCIe bus system of computer 302 can include a root complex 312 and one or more PCIe switches and associated logic that, in some embodiments, can be integrated in root complex 312. Alternatively, in some embodiments, one or more PCIe switches can be discrete devices coupled to root complex 312. Root complex 312 can be implemented as a discrete device coupled to computer 302 or can be integrated with computer 302. Root complex 312 can have any suitable logic and PCIe switching components needed to generate transaction requests and to route traffic between coupled devices and/or components (“endpoints”). Root complex 312 can support peer-to-peer transfers between PCIe endpoints, such as, for example, GPU 310, data source device 304, and data destination device 305. The PCIe bus system can also include PCIe buses 314, 315, and 320. PCIe bus 314 can couple data source device 304 to root complex 312. PCIe bus 315 can couple data destination device 305 to root complex 312. And PCIe bus 320 can couple GPU 310 to root complex 312. CPU 306 and host memory 308 can be coupled to root complex 312 via local buses 316 and 318, respectively. In some embodiments, computer 302 can include three One Stop Systems PCIe x1 HIB2 host bus adapters, available from One Stop Systems, Inc. of Escondido, Calif.

System 300 can operate with low I/O latency in a manner similar to that of system 200 in some embodiments. That is, by streaming data directly into GPU memory from data source device 304 and/or by streaming data directly out of GPU memory to data destination device 305, I/O latencies can be at levels suitable for real-time control and/or data processing applications. In some embodiments, direct data transfers between the GPU and the data source device and/or the data destination device can be configured by directing a GPU driver to cause a region in the GPU's memory to be allocated as a data store and then by exposing that region to the data source device and/or the data destination device. This can enable the data source device and/or the data destination device to communicate directly with the GPU, bypassing the CPU and host memory. In some embodiments, system 300 can be configured to operate in this manner as set forth below.

During power-up/initialization of system 300, every PCIe endpoint can be assigned one or more computer bus address ranges. In some embodiments, up to six computer bus address ranges can be assigned to each PCIe endpoint. The computer bus address ranges can be referred to as PCIe base addresses or base address registers (BARs). Each BAR can represent an address range in the PCIe memory space that can be mapped into a memory on a respective PCIe device (such as GPU 310, data source device 304, and data destination device 305). In some embodiments, each assigned address range can be, for example, up to 256 MB. When computer 302 powers-up, computer 302's BIOS (“basic input output system” software), EFI (“extensible firmware interface” software), and/or operating system can assign or determine the BARs for each attached device. For example, in some embodiments, a BIOS or EFI can assign specific BARs to, for example, the GPU, data source device, and data destination device. Alternatively, in some embodiments, the root complex can assign the BARs, and the operating system can then query the root complex for the assigned BARs. The operating system can pass the BARs for each device to that device's corresponding device driver, which is typically loaded into host memory. The corresponding device driver can then use the BARs to communicate with its corresponding device. For example, the operating system can assign or determine the BARs of GPU 310, and can then pass those BARs to a GPU device driver. The GPU device driver can use the BARs to communicate with GPU 310. In Unix-like operating systems, the driver can create a couple of device nodes in the file system. User-space programs can then communicate with the driver by writing, reading, or issuing ioctl (input/output control) requests on these device nodes. Alternatively, in some embodiments, the assignment of bus address ranges and the communicating of those ranges to appropriate device drivers can be made in any suitable manner.

In some embodiments, upon assignment of the BARs, the GPU driver can instruct GPU 310 to allocate a specific region in GPU memory as a data store. The GPU driver can next, in some embodiments, instruct GPU 310 to map that allocated region to one or more of the GPU's assigned BARs. The GPU BARs can then be transmitted by, for example, CPU 306, using the assigned BARs of other devices, to those devices that are to communicate with GPU 310 (such as, e.g., data source device 304 and/or data destination device 305). Instructions to write data to or read data from the GPU using the GPU BARs can also be transmitted by, for example, CPU 306 to the devices that are to communicate with GPU 310. Alternatively, in some embodiments, the allocation of GPU memory as a data store, the mapping of that allocated region to one or more assigned BARs, and the communicating of assigned GPU BARs to other devices can be made in any other suitable manner.

Once this setup is complete, data source device 304 and/or data destination device 305 can access the allocated GPU memory region directly via the computer bus (e.g., a PCIe bus system), bypassing CPU 306 and host memory 308. Thus, for example, in some embodiments, data source device 304 or other devices can be operative to push (i.e., write) data to be processed directly into GPU memory without any involvement by CPU 306 or host memory 308. Similarly, in some embodiments, the same or other devices (e.g., data destination device 305) can be operative to pull (i.e., read) data directly from GPU memory, again, without any involvement by CPU 306 or host memory 308. In some embodiments, these transfers can be direct memory access (DMA) transfers, which is a feature that allows certain devices/components to access a memory to transfer data (e.g., to read from or write to a memory) independently of the CPU.

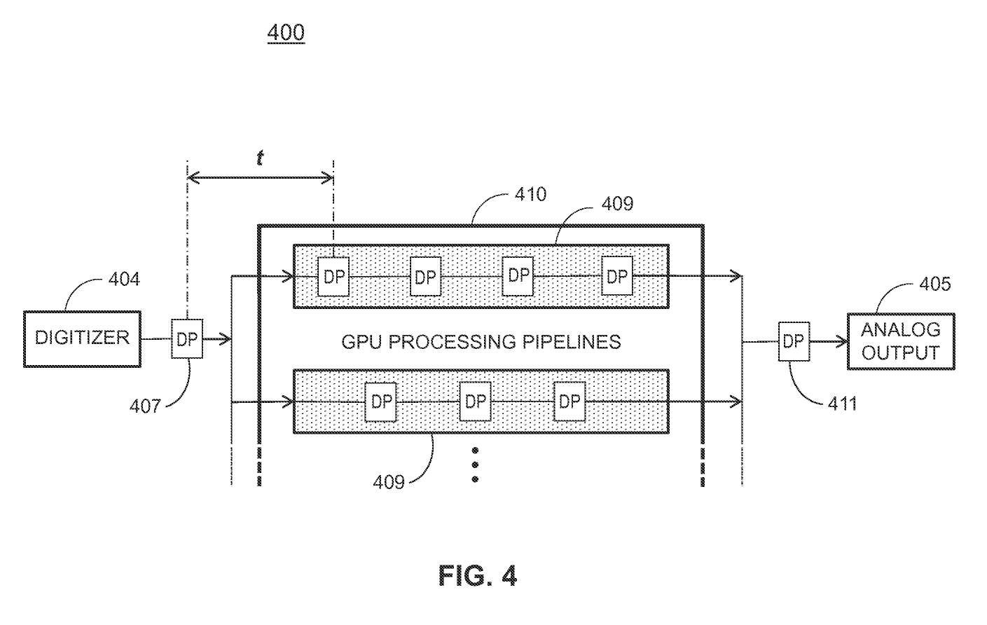

FIG. 4 illustrates data flow in a system 400 that can use GPU computing for real-time, low latency applications in accordance with some embodiments. One or more digitizers 404 can provide data packets (DPs) 407 to GPU 410. Processing of data packets 407 at GPU 410 can be pipelined and parallel. For example, system 400 can be used to run a control system algorithm that involves the application of a matrix to incoming data packets that can be, for example, 96×64 (number of inputs×number of outputs). In some embodiments, the algorithm can be implemented in CUDA (compute unified device architecture), which is a parallel computing architecture developed by NVIDIA Corporation, of Santa Clara, Calif. CUDA can provide a high-level API (application programming interface) for communicating with a GPU device driver in some embodiments. The algorithm can assign, for example, three threads to every element of the output vector, and can then calculate all elements in parallel, resulting in 64 GPU processing pipelines 409 of three threads each. Processed data packets 411 can be received by one or more analog outputs 405. GPU 410 can manually and/or automatically distribute the processing threads among the available processing cores in accordance with some embodiments, taking into account the nature of the required computations.

Performance of system 400 can be indicated by cycle time and I/O latency. In some embodiments, I/O latency can be the time delay between a change in the analog control input and the corresponding change in the analog control output. In some embodiments, cycle time can be the rate at which system 400 reads new input samples and updates its output signals. That is, the cycle time can be the time spacing between subsequent data packets. This can be illustrated by cycle time t in FIG. 4. In some embodiments, system 400 using GPU 410 to run a plasma control algorithm can achieve, for example, a cycle time of about 5 μs and I/O latencies below about 10 μs for up to 96 inputs and 64 outputs. Because the processing can be pipelined and parallel, the achievable cycle time can, in some embodiments, be effectively independent of a control algorithm's complexity. Moreover, in some embodiments, the reading of output data can be completely symmetric to the writing of input data and can thus always run at the same rate. Note however, that in some embodiments, system 400 can have different input and output cycle times.

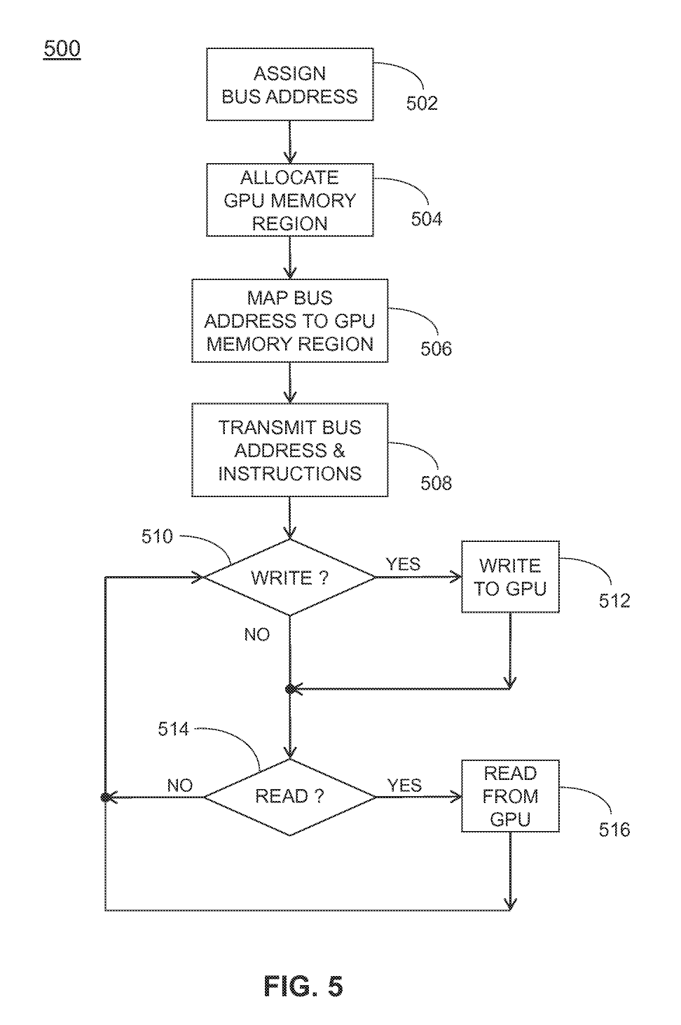

FIG. 5 illustrates an example of a flow diagram of a process 500 for using a GPU in control and/or data processing systems in accordance with some embodiments. The control and/or data processing systems can be, in some embodiments, required to operate with low I/O latency and/or be suitable for use with real-time process control and/or data processing applications. In some embodiments, process 500 can be used with system 200, 300, and/or 400. At block 502, one or more computer bus address ranges can be assigned to each device and/or component coupled to the system's computer bus. The coupled devices and/or components can include a GPU, at least one data source device, and/or at least one data destination device. In some embodiments, the computer bus can be based on, for example, a PCI bus standard such as PCIe, and the one or more bus address ranges can be represented by one or more base address registers (BARs). In some embodiments, each device and/or component can be assigned up to six BARs, and each BAR can represent up to 256 MB. The assignment of bus address ranges can occur during system power-up/system initialization and, in some embodiments, the assignment of computer bus address ranges can be made by the CPU operating system, BIOS, and/or EFI. Alternatively, in some embodiments, the assignment of bus address ranges can be made by the computer bus (e.g., by a PCIe root complex in some embodiments). In such alternative cases, the CPU operating system can query the computer bus for the assigned bus address ranges of each coupled device and/or component. In some embodiments, the assignment of bus address ranges can instead be made in any other suitable manner.

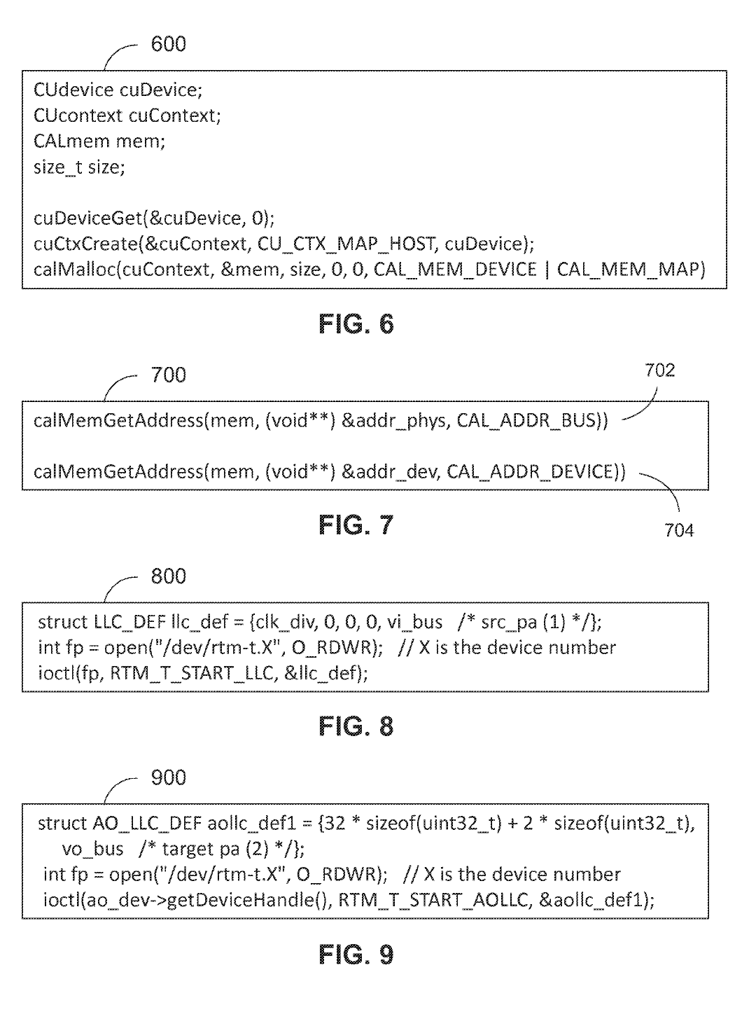

At block 504, a region of GPU memory can be allocated as a data store. In some embodiments, the size of the allocated region can be less than or greater than the size of the assigned BAR(s). However, the maximum amount of data that can be transferred into or out of GPU memory in a given read or write operation can be limited to the size of the assigned BAR(s). In some embodiments where, for example, six BARs are assigned to the GPU, each BAR having a size of 256 MB, one or more GPU memory regions totaling 1536 MB can be allocated. Note that the allocated regions do not have to be continuous in some embodiments. For example, 12 regions of 128 MB each can be allocated where six BARs of 256 MB each are assigned to the GPU. In some embodiments, a GPU driver can be programmed to instruct the GPU to perform this allocation function. To program a GPU driver accordingly in some embodiments, a GPU compiler and/or library by PathScale, Inc., of Wilmington, Del., can be used as described below in connection with FIG. 6.

At block 506, a bus address range assigned to the GPU can be mapped to the allocated region of GPU memory. In some embodiments, mapping of BARs to allocated regions in GPU memory can be dynamic and/or managed by an MMU (memory management unit) of the GPU. In some embodiments, a GPU driver can be programmed to instruct the GPU to perform this function. To program a GPU driver accordingly in some embodiments, a GPU compiler and/or library by PathScale, Inc., of Wilmington, Del., can be used as described below in connection with FIG. 6. In some embodiments, block 506 can be omitted where the GPU is set up in such a way that the device address of the allocated region coincides with the bus address.

FIG. 6 shows an example of programming code 600 written in programming language C that can be used to allocate a region in GPU memory and map an assigned BAR to that region. Code 600 can cause a region of size size to be allocated and a handle to the allocated region to be saved in the variable mem. The function call “calMalloc” can be used to allocate a GPU memory region and to map the allocated region to a BAR. Other suitable programming code can be used in some embodiments to program the GPU driver. For example, in some embodiments, allocating the memory region and mapping all or parts of the allocated region into a BAR may be performed separately using two distinct function calls.

FIG. 7 shows an example of programming code 700 written in programming language C that can instruct the GPU driver to retrieve the addresses of the mapped region. In particular, execution of instruction 702 can cause the assigned bus address of the allocated GPU memory region referred to by the mem handle to be saved in the variable addr_phys. Execution of instruction 704 can cause the GPU device address of the allocated region referred to by the mem handle to be saved in the variable addr_dev. The device address is the address that the code running on the GPU can use to access the allocated region. Other suitable programming code can be used in some embodiments to program the GPU driver.

Returning to FIG. 5 at block 508, the bus address range of the GPU (corresponding to the allocated memory region of the GPU) and/or address information related thereto can be transmitted to each data source device and/or each data destination device that are to communicate with the GPU. Instructions to use the bus address range for communicating with the GPU can also be transmitted to each data source device and/or each data destination device that are to communicate with the GPU. In some embodiments, this function can be performed by the CPU's operating system each time data processing is initialized, which can be each time a new set of data is to be processed in accordance with an application running on the system. For example, if the application involves the processing of data from a series of experiments, this function (and in some embodiments, the functions of blocks 504 and 506) can be performed at the beginning of each experiment (without the system having to be reinitialized). FIG. 8 shows an example of programming code 800 written in programming language C that when executed performs the function of transmitting to a data source device the GPU bus address range and/or address information related thereto and instructions to use that range and/or related address information in accordance with some embodiments. FIG. 9 shows an example of programming code 900 written in programming language C that when executed performs the function of transmitting to a data destination device the GPU bus address range and/or address information related thereto and instructions to use that range and/or related address information in accordance with some embodiments. The transmitted information can be directly communicated to the kernel driver of each data source device and/or each data destination device in some embodiments. Note that programming codes 800 and 900 are applicable to D-TACQ RTM-T source and destination devices such as those described above in connection with system 300. Other suitable programming code can be used in some embodiments to communicate the bus address range and instructions to data source devices and/or data destination devices.

Process 500 can determine at decision block 510 whether a GPU write request from a data source device is received by the computer bus. A data source device can issue write requests as data becomes available, at regular intervals, or in any other suitable manner. In some embodiments, a data source device can initiate a direct memory access (DMA) transfer to the GPU. In response to receiving a write request, process 500 can proceed to block 512. Otherwise, process 500 can proceed to decision block 514.

At block 512, data and/or control information from the data source device issuing the write request can be transferred (i.e., “written”) to the GPU's memory. In some embodiments, this transfer does not involve the GPU driver, the CPU, or the host memory of the system. In other words, the GPU driver, the CPU, and the host memory can be bypassed during the write operation. In some embodiments, data written to the GPU's memory can be processed by the GPU in accordance with an application executing on the system. Processed data can then be returned to the GPU's memory in some embodiments.

Process 500 can determine at decision block 514 whether a GPU read request from a data destination device is received by the computer bus. Read requests from a data destination device can be issued at regular intervals based on, for example, GPU cycle time, or read requests can be issued at any other suitable interval, time, and/or event. In some embodiments, a data destination device can initiate a DMA transfer from the GPU. If a read request is received, process 500 can proceed to block 516. Otherwise, process 500 can loop back to decision block 510 to again determine whether a GPU write request is received by the computer bus.

At block 516, requested data can be transferred (i.e., “read”) from the GPU's memory to a data destination device. In some embodiments, this transfer does not involve the GPU driver, the CPU, or the host memory. In other words, the GPU driver, the CPU, and the host memory can be bypassed during the read operation. Upon completion of the read request, process 500 can loop back to decision block 510 to again determine whether a GPU write request is received by the computer bus.

Note that the process steps of the flow diagram in FIG. 5 can be executed or performed in an order or sequence other than the order and sequence shown in FIG. 5 and described above. For example, some of the steps can be executed or performed substantially simultaneously or in parallel where appropriate to reduce latency and processing times. In some embodiments, for example, process 500 can have a first sub-process comprising blocks 510 and 512 (wherein a data source device sends data to the GPU at specified intervals or whenever data is ready) running independently and in parallel with a second sub-process comprising blocks 514 and 516 (wherein a data destination device reads results from the GPU memory at, for example, specified intervals).

Systems, methods, and media, such as, for example, systems 200, 300 and/or 400 and/or process 500, can be used in accordance with some embodiments in a wide variety of applications including, for example, computationally expensive, low-latency, real-time applications. In some embodiments, such systems, methods, and/or media can be used in: (1) feedback systems operating in the microsecond regime with either large numbers of inputs and outputs and/or complex control algorithms; (2) feedback control in any suitable high speed, precision system such as manufacturing automation and/or aeronautics; (3) feedback control for large-scale chemical processing, where many variables need to be monitored simultaneously; (4) mechanical or electrical engineering applications that require fast feedback and/or complex processing such as automobile navigation systems that use real-time imaging to provide situation specific assistance (such as, e.g., systems that can read and understand signs, detect potentially dangerous velocity, car-to-car distance, crossing pedestrians, etc.); (5) high-speed processing of short-range wide band communications signals to direct beam forming and antenna tuning and/or decode and/or error correct a large amount of data received in multiple parallel streams; (6) atomic force and/or scanning tunnel microscopy to regulate a distance between a probe and a surface in real-time with the precision of about a nanometer and/or to provide parallel probing; (7) “fly-by-wire” control systems for civilian and/or military aircraft control and/or navigation; (8) control of autonomous vehicles such as reconnaissance drones; (9) medical imaging technologies, such as MRI (magnetic resonance imaging), that need to be processed in real time to, e.g., provide live-imagery during surgery; and/or (10) scientific applications, such as, e.g., feedback stabilization of intrinsically unstable experiments such as magnetically confined nuclear fusion. Such systems, methods, and media can additionally or alternatively be used for any suitable purpose.

In accordance with some embodiments, and additionally or alternatively to that described above, the techniques described herein can be implemented at least in part in one or more computer systems. These computer systems can be include any of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input/output devices, etc. Furthermore, in some embodiments, a GPU need not necessarily include, for example, a display connector and/or any other component exclusively required for producing graphics.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

1. A method of using a graphics processing unit in a control or data processing system, the method comprising:
receiving, by a graphics processing unit, a first instruction from a central processing unit coupled to the graphics processing unit to allocate a region of memory of the graphics processing unit as a data store;
receiving, by the graphics processing unit, a second instruction from a data source device to store information in the region of memory;
generating, by the graphics processing unit, processed data based on the information stored in the region of memory;
storing, by the graphics processing unit, the processed data in the region of memory; and
receiving, by the graphics processing unit, a third instruction from a data destination device to read the processed data from the region of memory and cause the processed data to be transmitted to the data destination device.

2. The method of claim 1 wherein the first instruction comprises a memory allocation instruction from a device driver of the graphics processing unit.

3. The method of claim 1, further comprising mapping, by the graphics processing unit, a region of physical memory of the graphics processing unit to a computer bus address range, wherein the computer bus address range is assigned to the graphics processing unit.

4. The method of claim 1, wherein the data source device and the destination device are the same device.

5. The method of claim 3, wherein the computer bus address range comprises a base address register (BAR) conforming to a Peripheral Component Interconnect Express (PCIe) bus standard.

6. The method of claim 1, wherein receiving the second instruction comprises:
receiving a write request from a computer bus to which the graphics processing unit, the data source device, and the central processing unit are coupled, wherein the write request is addressed to the region of memory of the graphics processing unit; and
writing data or control information, by the graphics processing unit, received directly from the data source device via the computer bus to the memory of the graphics processing unit.

7. The method of claim 1, wherein receiving the third instruction comprises:
receiving a read request from a computer bus to which the graphics processing unit, the data source device, and the central processing unit are coupled, wherein the read request is addressed to the region of memory of the graphics processing unit; and
reading the processed data from the memory of the graphics processing unit, by the graphics processing unit, directly to the data destination device via the computer bus.

8. A system for using a graphics processing unit for process control or data processing applications, the system comprising:
a graphics processing unit comprising memory, the graphics processing unit configured to;
receive a first instruction from a central processing unit coupled to the graphics processing unit to allocate a region of the memory as a data store;
receive a second instruction from a data source device to store information in the region of memory;
generate processed data based on the information stored in the region of memory;
store the processed data in the region of memory; and
receive a third instruction from a data destination device to read the processed data from the region of memory and cause the processed data to be transmitted to the data destination device.

9. The system of claim 8, wherein the first instruction comprises a memory allocation instruction from a device driver of the graphics processing unit.

10. The system of claim 8, comprising mapping, by the graphics processing unit, a region of physical memory of the graphics processing unit to a computer bus address range, wherein the computer bus address range is assigned to the graphics processing unit.

11. The system of claim 8, wherein the data source device and the destination device are the same device.

12. The system of claim 10, wherein the computer bus address range comprises a base address register (BAR) conforming to a Peripheral Component Interconnect Express (PCIe) bus standard.

13. The system of claim 8, wherein the graphics processing unit is further configured to:
receive a write request from a computer bus to which the graphics processing unit, the data source device, and the central processing unit are coupled, wherein the write request is addressed to the region of memory of the graphics processing unit; and
write data or control information received directly from the data source device via the computer bus to the memory of the graphics processing unit.

14. The system of claim 8, wherein the graphics processing unit is further configured to:
receive a read request from a computer bus to which the graphics processing unit, the data destination device, and the central processing unit are coupled, wherein the read request is addressed to the region of memory of the graphics processing unit; and
read the processed data from the memory of the graphics processing unit directly to the data destination device via the computer bus.

15. The system of claim 8, wherein the graphics processing unit comprises about 512 stream processors and about 1.5 gigabytes of random access memory.

16. A non-transitory computer-readable medium containing computer-executable instructions that, when executed by a processor, cause the processor to perform a method of using a graphics processing unit in a control or data processing system, the method comprising:
receiving a first instruction from a central processing unit coupled to the graphics processing unit to allocate a region of memory of the graphics processing unit as a data store;
receiving, by the graphics processing unit, a second instruction from a data source device to store information in the region of memory;
generating, by the graphics processing unit, processed data based on the information stored in the region of memory;
storing, by the graphics processing unit, the processed data in the region of memory; and
receiving, by the graphics processing unit, a third instruction from a data destination device to read the processed data from the region of memory and cause the processed data to be transmitted to the data destination device.

17. The non-transitory computer-readable medium of claim 16, wherein the first instruction comprises a memory allocation instruction from a device driver of the graphics processing unit.

18. The non-transitory computer-readable medium of claim 16, wherein the method further comprises mapping, by the graphics processing unit, a region of physical memory to a computer bus address range, wherein the computer bus address range is assigned to the graphics processing unit.

19. The non-transitory computer-readable medium of claim 16, wherein receiving the second instruction comprises:
receiving a write request from a computer bus to which the graphics processing unit, the data source device, and the central processing unit are coupled, wherein the write request is addressed to the region of memory of the graphics processing unit; and
writing data or control information received directly from the data source device directly via the computer bus to the memory of the graphics processing unit.

20. The non-transitory computer-readable medium of claim 16, wherein receiving the third instruction comprises:
receiving a read request from a computer bus to which the graphics processing unit, the data destination device, and the central processing unit are coupled, wherein the read request is addressed to the region of memory of the graphics processing unit; and
reading the processed data from the memory of the graphics processing unit directly to the data destination device via the computer bus.

21. The non-transitory computer-readable medium of claim 16, wherein the data source device and the destination device are the same device.

22. The non-transitory computer-readable medium of claim 18, wherein the computer bus address range comprises a base address register (BAR) conforming to a Peripheral Component Interconnect Express (PCIe) bus standard.
